(19) United States
(12) Patent Application Publication
(10) Pub. No.: US 2025/0370729 A1
(43) Pub. Date: Dec. 4, 2025

(54) SOFTWARE DEVELOPMENT AGENT THAT LEVERAGES APPLICATION BEHAVIORAL MODELS

(71) Applicant: AppLand Inc., Weston, MA (US)

(72) Inventors: Elizabeth Lawler, Weston, MA (US); Kevin Gilpin, Weston, MA (US); Dustin Byrne, Lunenburg, MA (US); Rafal Rzepecki, Wroclaw (PL)

(21) Appl. No.: 18/893,257

(22) Filed: Sep. 23, 2024

Related U.S. Application Data
(60) Provisional application No. 63/654,641, filed on May 31, 2024.

(51) Int. Cl. G06F 8/35; G06F 11/36; G06F 40/279

(52) U.S. Cl. CPC G06F 8/35; G06F 11/3636; G06F 11/3684; G06F 11/3688; G06F 40/279

(57) ABSTRACT

To assist users in artificial intelligence driven software development, techniques for agentic software development assistance leveraging application behavioral models are disclosed. A software agent receives a codebase issue and orchestrates an iteration of a refining process. To orchestrate the process, the software agent feeds the codebase issue and instructions to generate a plan into a development assistant, which automatically returns a plan to the agent. The agent feeds the plan and instructions to generate a solution to the codebase issue back to the development assistant, which automatically returns a solution to the agent. The agent feeds the solution back to the development assistant, which tests the solution in order to verify the solution's quality in responding to the codebase issue. The solution is awarded a quality score, and the quality score is returned to the agent. Based on the quality score, another iteration of the refining process can be performed.

### CROSS REFERENCE TO RELATED APPLICATIONS

This application claims priority to U.S. Provisional Patent Application No. 63/654,641, titled “AGENTIC SOFTWARE DEVELOPMENT LEVERAGING APPLICATION BEHAVIORAL MODELS,” filed May 31, 2024, the contents of which is incorporated by reference in its entirety for all purposes.

### TECHNICAL FIELD

Aspects of the disclosure are related to the field of computer software applications and, in particular, to software development assistance leveraging behavioral models and generative artificial intelligence.

### BACKGROUND

Generating and maintaining robust and reliable software requires testing the codebase to identify and address issues impacting the quality, performance, and security of the software. However, codebases can be very large, and identifying all potential issues, finding and understanding particular elements within a codebase, and the like can be challenging.

With increasing frequency, software developers are leveraging artificial intelligence tools to more efficiently overcome the challenges associated with generating and maintaining codebases. In particular, artificial intelligence models can be trained to develop and revise software to respond to particular issues in the codebase. However, managing the artificial intelligence tools with respect to developing and revising software remains a significant labor. Further, artificial intelligence tools commonly fail to adequately address codebase issues.

Existing techniques improve the output quality of artificial intelligence tools with respect to solving codebase issues by using increased token limits when querying generative artificial intelligence models. While these techniques may result in some improvement to the output quality of artificial intelligence tools, the increased costs associated with higher token limits may offset the benefit of leveraging the artificial intelligence tools in the first place. Accordingly, tools to assist users in artificial intelligence driven software development are needed.

### SUMMARY

To assist users in artificial intelligence driven software development, techniques for agentic software development assistance leveraging application behavioral models are disclosed. A software agent receives a codebase issue and orchestrates an iteration of a refining process. Refining generally describes fine-tuning a solution to a codebase issue in order to improve characteristics of the solution, such as degree of success in responding to the codebase issue. To orchestrate the process, the software agent feeds the codebase issue and instructions to generate a plan into a development assistant, which automatically returns a plan to the agent. The agent feeds the plan and instructions to generate a solution to the codebase issue back to the development assistant, which automatically returns a solution to the agent. The agent feeds the solution back to the development assistant, which tests the solution in order to verify the solution's quality in responding to the codebase issue. The solution is awarded a quality score, and the quality score is returned to the agent. Based on the quality score, another iteration of the refining process can be performed.

Disclosed are methods and computer readable media for providing agentic software development assistance. To begin, a refining agent receives a codebase issue. The codebase issue is associated with an initial codebase and a behavioral model. The refining agent then orchestrates a first iteration of a refining process. To orchestrate the first iteration of the refining process, the refining agent directs a development assistant to generate a plan. To generate the plan, the development assistant is configured to identify context info that corresponds to the codebase issue. The context info includes a portion of the initial codebase and a portion of the behavioral model. The development assistant is further configured to generate a plan prompt designed to elicit a response from a foundation model. The plan prompt includes instructions that task the foundation model with generating a plan for responding to the codebase issue, the codebase issue itself, and the context info.

The refining agent further directs the development assistant to generate a solution for the codebase issue. The solution for the codebase issue has new code that, when included in the initial codebase, is intended to be responsive to the codebase issue. The development assistant generates a revised codebase based on the initial codebase and solution. The development assistant also generates test cases that correspond to the codebase issue. The development assistant then executes the test cases against the revised codebase. The refining agent determines a quality score for the solution based on the execution of the test cases against the revised codebase. The refining agent then executes, based on the quality score, a second iteration of the refining process.

In some embodiments, a portion of the behavioral model that corresponds to the codebase issue is identified. In such embodiments, a portion of the initial codebase corresponding to the codebase issue is identified based on the portion of the behavioral model. In a number of such embodiments, identifying the portion of the behavioral model corresponding to the codebase issue is performed by generating a keyword list based on the codebase issue and searching for locations within the behavioral model associated with the codebase issue based on the keyword list.

In some embodiments, the refining agent determines, prior to orchestrating the first iteration of the refining process, that the behavioral model is not generated. In response, the refining agent generates the behavioral model by recording an execution of the initial codebase.

In some embodiments, a second quality score is determined subsequent to the second iteration of the refining process. In such embodiments, further iterations of the refining process for the codebase issue are not executed based on the second quality score.

In some embodiments, the plan includes a number of steps designed to respond to the codebase issue.

In some embodiments, the development assistant is further configured to submit a solution context to the foundation model while generating the solution. In such embodiments, the solution context includes one or more code snippets selected from the initial codebase. The one or more code snippets are selected such that they correspond to the codebase issue.

In some embodiments, prior to executing the second iteration of the refining process, the refining agent generates an updated behavioral model corresponding to the revised code.

In some embodiments, the second iteration includes refining the revised codebase.

In some embodiments, the second iteration includes refining the initial codebase.

In some embodiments, the refining agent receives the codebase issue from an issue management system.

In some embodiments, the refining agent receives the codebase issue via a user interface. In a number of such embodiments, the refining agent receives a command input via a user interface in addition to the codebase issue. In such embodiments, the command input corresponds to one or more specific software agents, one or more portions of the development assistant, one or more issue types, one or more test case types, or a combination thereof.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operating environment in accordance with some embodiments of the present technology.

FIG. 2 illustrates a connection broker in further detail in accordance with some embodiments of the present technology.

FIG. 3 illustrates another operating environment in accordance with some embodiments of the present technology.

FIG. 4 illustrates a method of orchestrating containerized workloads in accordance with some embodiments of the present technology.

FIG. 5 illustrates a software flow diagram in accordance with some embodiments of the present technology.

FIG. 6 illustrates computing system used in accordance with some embodiments of the present technology.

FIG. 7 illustrates a user interface in accordance with some embodiments of the present technology.

FIG. 8A illustrates an operating environment in further detail in accordance with some embodiments of the present technology.

FIG. 8B illustrates a phase of an operational scenario in further detail in accordance with some embodiments of the present technology.

FIG. 8C illustrates another phase of operational scenario in further detail in accordance with some embodiments of the present technology.

FIG. 8D illustrates another phase of operational scenario in further detail in accordance with some embodiments of the present technology.

FIG. 8E another phase of operational scenario in further detail in accordance with some embodiments of the present technology.

FIG. 9 illustrates computing system used in accordance with some embodiments of the present technology.

### DETAILED DESCRIPTION

Various implementations are disclosed herein that describe technology for assisting users in artificial intelligence driven software development, providing agentic software development assistance leveraging application behavioral models are disclosed. A refining agent receives a codebase issue and orchestrates a refining process iteration to agentically address and mitigate the codebase issue. To orchestrate the iteration, the refining agent leverages a development assistant. The development assistant is an artificially intelligent software architect that assists developers in understanding, responding to, and verifying responses for a wide range of codebase issues.

The refining agent feeds the codebase issue into the development assistant, which processes the codebase issue and returns a plan for responding to the codebase issue. The refining agent feeds the plan back into the development assistant, which processes the plan and returns an explicit solution detailing the revisions to be made to the initial codebase corresponding to the codebase issue in order to address the codebase issue. The refining agent feeds the solution back into the development assistant, which revises the initial codebase associated with the codebase issue based on the solution, generates test cases for the newly revised codebase, and executes the test cases against the revised codebase. The refining agent observes the executions of the test cases and determines a quality score for the solution with respect to the codebase issue. The refining agent then executes a second iteration of the refining process based on the quality score for the solution.

To obtain AI-generated responses from the development assistant which are specific to the codebase issue, prompts to the foundation model are highly contextualized by the inclusion of selected portions of the behavioral model and selected snippets from the initial codebase. In one process, the user query is initially submitted to the foundation model which is tasked with generating a list of search terms or keywords based on the query or relating to the query, such as a list of words, terms (e.g., coding terms), phrases, function definitions, identifiers, and so on. Upon receiving the keyword expansion list from the foundation model, the system performs a search, such as a Best Match 25 (BM25) search, of the behavioral model of the initial codebase to identify code paths and locations, I/O (input output) events, SQL (structured query language) queries, HTTP (hypertext transfer protocol) server/client requests, and so on in the behavioral model which are of particular relevance to the user query. Upon identifying the relevant locations in the behavioral model, the system then searches the portions of the initial codebase associated with the identified locations to identify code snippets which are relevant to the query based on the keyword list. Having identified relevant locations in the behavioral model and relevant code snippets in the initial codebase, this information is supplied to the foundation model to provide the context for the model to generate its reply. In this way, the model is able to generate a targeted response which is complete and specific to the user's initial codebase. Additionally, the content of the targeted response may be used by the system to surface visual representations of the relevant locations of the behavioral model and/or the relevant code snippets in the user interface when displaying the reply.

Foundation models of the technology disclosed herein include large-scale generative artificial intelligence (AI) models trained on massive quantities of diverse, unlabeled data using self-supervised, semi-supervised, or unsupervised learning techniques. Foundation models may be based on a number of different architectures, such as generative adversarial networks (GANs), variational auto-encoders (VAEs), and transformer models, including multimodal transformer models. Foundation models capture general knowledge, semantic representations, and patterns and regularities in or from the data, making them capable of performing a wide range of downstream tasks. In some scenarios, a foundation model may be fine-tuned for specific downstream tasks. Foundation models include BERT (Bidirectional Encoder Representations from Transformers) and ResNet (Residual Neural Network). Example foundation models include GPT-3, GPT-4, and the like. Types of foundation models may be broadly classified as or include pre-trained models, base models, and knowledge models, depending on the particular characteristics or usage of the model. Foundation models may be multimodal or unimodal depending on the modality of the inputs.

Multimodal models are a class of foundation model which extend their pre-trained knowledge and representation capabilities to handle multimodal data, such as text, image, video, and audio data. Multimodal models may leverage techniques like attention mechanisms and shared encoders to fuse information from different modalities and create joint representations. Learning joint representations across different modalities enables multimodal models to generate multimodal outputs that are coherent, diverse, expressive, and contextually rich. For example, multimodal models can generate a caption or textual description of the given image by extracting visual features using an image encoder, then feeding the visual features to a language decoder to generate a descriptive caption. Similarly, multimodal models can generate an image based on a text description (or, in some scenarios, a spoken description transcribed by a speech-to-text engine). Multimodal models work in a similar fashion with video—generating a text description of the video or generating video based on a text description.

Multimodal models include visual-language foundation models, such as CLIP (Contrastive Language-Image Pre-training), ALIGN (A Large-scale ImaGe and Noisy-text embedding), and VILBERT (Visual-and-Language BERT), for computer vision tasks. Examples of visual multimodal or foundation models include DALL-E, DALL-E 2, Flamingo, Florence, and NOOR. Types of multimodal models may be broadly classified as or include cross-modal models, multimodal fusion models, and audio-visual models, depending on the particular characteristics or usage of the model.

Large language models (LLMs) are a type of foundation model which processes and generates natural language text. These models are trained on massive amounts of text data and learn to generate coherent and contextually relevant responses given a prompt or input text. LLMs are capable of understanding and generating sophisticated language based on their trained capacity to capture intricate patterns, semantics, and contextual dependencies in textual data. In some scenarios, LLMs may incorporate additional modalities, such as combining images or audio input along with textual input to generate multimodal outputs. Types of LLMs include language generation models, language understanding models, and transformer models.

Transformer models, including transformer-type foundation models and transformer-type LLMs, are a class of deep learning models used in natural language processing (NLP). Transformer models are based on a neural network architecture which uses self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, BERT (Bidirectional Encoder Representations from Transformer) models, ERNIE (Enhanced Representation through kNowledge Integration) models, T5 (Text-to-Text Transfer Transformer), and XLNet models are types of transformer models which have been pretrained on large amounts of text data using a self-supervised learning technique called masked language modeling. Indeed, large language models, such as GPT-3 and its brethren, have been pretrained on an immense amount of data across virtually every domain of the arts and sciences. This pretraining allows the models to learn a rich representation of language that can be fine-tuned for specific NLP tasks, such as text generation, language translation, or sentiment analysis. Moreover, these models have demonstrated emergent capabilities in generating responses which are creative, open-ended, and unpredictable.

In one embodiment, a refining agent of an agentic software development tool instructs an ingestion agent to receive a codebase issue. The codebase issue is generally representative of a problem with the operation of an initial codebase, and could be for example a failure to compile, a failure to perform a given task, a memory leak, or other initial codebase problems. The refining agent instructs an interrogation agent to identify an initial codebase, and a behavioral model associated with the codebase issue. The behavioral model is a representation of the behavior of the initial codebase during execution. Accordingly, the behavioral model is generated based on recording execution of the initial codebase.

The refining agent then begins orchestrating an iteration of an agentic software development process. A context engine is directed, using the identified initial codebase and behavioral model, to determine an issue context. The issue context may include, for example, portions of the initial codebase and behavioral model that are specifically relevant to the codebase issue. Beneficially, this minimizes the volume of data used to generate a solution, thereby decreasing the cost of operation. Based on the issue context, the refining agent directs a solution engine to provide a solution to the codebase issue and test cases for evaluating the solution. The solution engine leverages a GenAI model to create the solution for the issue given the provided context.

An implementation agent is directed to incorporate the solution into the initial codebase. In some cases, the revised codebase simply includes the initial codebase with additional code representing the solution. In other cases, the solution may overwrite, or delete entirely, existing portions of the initial codebase. A testing agent is directed to evaluate an execution of the revised codebase. Evaluating an execution of the revised codebase allows the testing agent to review the performance of the revised codebase with respect to the codebase issue. The testing agent executes the test cases obtained from the solution engine against the modified codebase. The execution of the test cases is recorded to generate a behavioral model of the modified codebase. Upon completion of the testing, the testing agent can determine whether the solution resolved the codebase issue.

Based on determining that the solution did not completely, sufficiently, or satisfactorily resolve the issue, the refining agent can execute another iteration of the agentic software development process. The refining agent uses the revised codebase and the subsequent behavioral model to direct the context agent to determine an updated issue context. The updated issue context includes both the first issue context and relevant portions of the revised codebase and subsequent behavioral model. The updated issue context is used to generate a subsequent solution and subsequent test cases, which are again evaluated by the testing agent. Based on the evaluation, additional subsequent iterations can be performed, each benefiting from the combination of the issue contexts of each previous iteration.

Various embodiments of the present technology provide for a wide range of technical effects, advantages, and/or improvements to computing systems and components. For example, the present technology can be operated with minimal oversight, substantially improving the time and resources required to develop and maintain robust and reliable software. While utilizing artificially intelligent software development tools may generally reduce the time and labor required to develop and maintain robust software, allowing a software agent to operate the artificially intelligent software development tools represents an even greater improvement in time and resource expenditure.

The present technology also allows for improved mitigation of codebase issues while preserving the need for minimal oversight as described above. To accomplish this, key words associated with the codebase issue are identified and used to locate portions of the behavioral model that are relevant to the codebase issue. The portions of the behavioral model can then be used to isolate portions of the initial codebase that are relevant to the codebase issue. By narrowing the initial codebase to just portions relevant to the codebase issue, the volume of information used to query the foundation model for the solution to the codebase issue can be significantly reduced. Beneficially, this allows iterations of the refining process to be performed while under lower foundation model token limits than would otherwise be the case, greatly reducing the overhead cost of operating the refining process. Further, a solution produced by a foundation model having received an input that is more focused on the problem to be solved is more likely to adequately address the problem than a foundation model having received an input that is less focused on the problem to be solved.

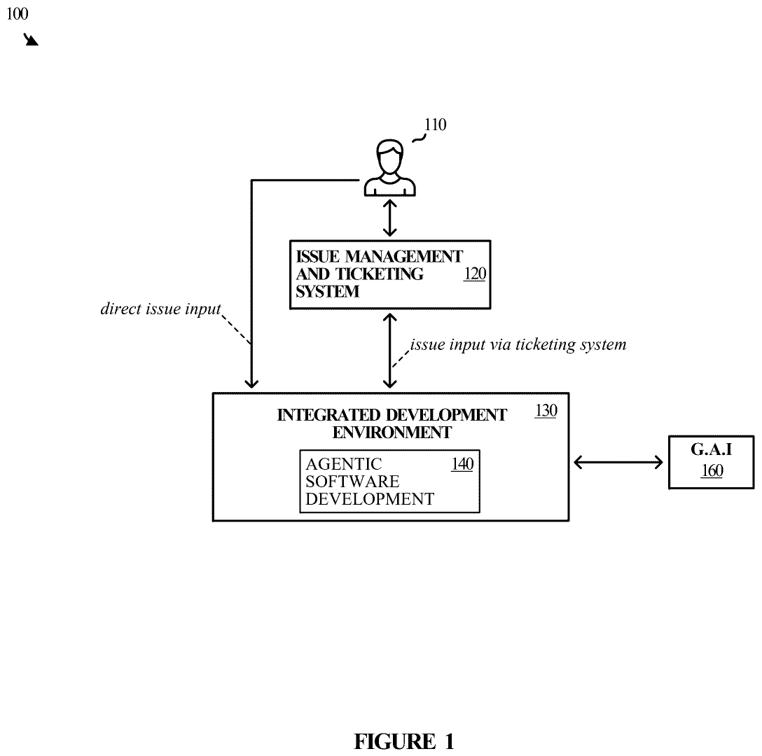

Turning to the figures, FIG. 1 illustrates operating environment 100 in an implementation. Operating environment 100 includes user 110, issue management and ticketing system 120, integrated development environment 130, hereinafter IDE 130, and generative artificial intelligence 160, hereinafter GAI 160. IDE 130 further includes agentic software development 140.

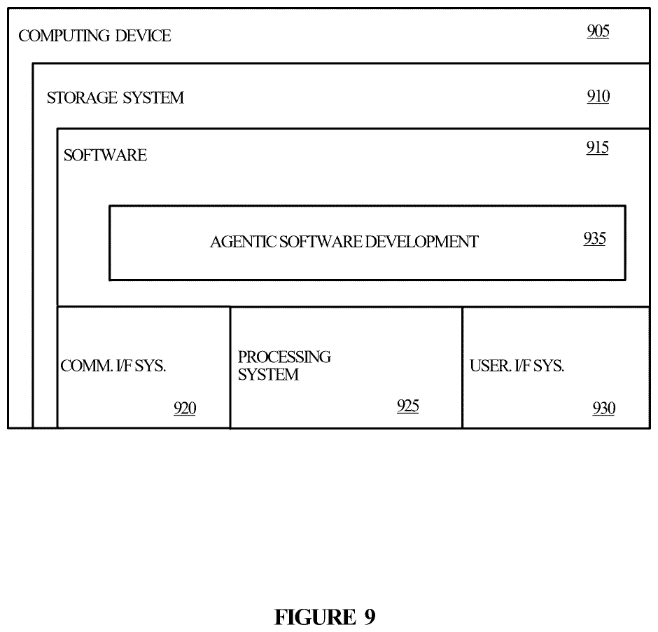

Operating environment 100 illustrates an environment for a system for agentically resolving queries based on an analysis of an initial codebase using behavioral models via a foundation model integration in an implementation. Agentic operation generally refers to autonomous operation of a process by a software agent. Operating environment 100 is generally representative of an environment in which agentic software development 140 can operate. Operating environment 100 may be a local computing device, a distributed computing device, or a combination thereof. Computing device 905 of FIG. 9 is generally representative of such an operating environment.

User 110 is generally representative of a user of computing systems and processes therein. User 110 may be a person, such as a software developer, or may otherwise be a software component. In either scenario, user 110 may trigger an agentic software development process, directly or indirectly. User 110 is communicatively coupled with issue management and ticketing system 120 and IDE 130. User 110 is generally responsible for adding codebase issues to issue management and ticketing system 120, though in some cases user 110 may input a codebase issue directly to agentic software development 140 via IDE 130.

Issue management and ticketing system 120 is generally representative of an application configured to assist in identifying, tracking, and resolving codebase issues. Issue management and ticketing system 120 may be implemented in software, hardware, or firmware and is communicatively coupled with user 110 and IDE 130.

Agentic software development 140 is generally representative of a module that provides agentic software development assistance and may be implemented in software, hardware, or firmware. Agentic software development 140 is configured to receive codebase issues and to provide iteratively optimized solutions to resolve the codebase issues.

GAI 160 is representative of one or more computing services capable of hosting a foundation model and communicating with development assistant 803. Agentic software development 140 queries GAI 160 to carry out agentic software development. GAI 160 may be implemented in the context of one or more server computers co-located or distributed across one or more data centers. GAI 160 is representative of a deep learning AI model, such as BERT, ERNIE, T5, XLNet, or of a generative pretrained transformer (GPT) computing architecture, such as GPT-3®, GPT-3.5, ChatGPT®, or GPT-4. GAI 160 communicates with agentic software development 140, including receiving natural language prompts and returning output, including computer code and natural language text, according to the prompt based on its training. Agentic software development 140 communicates with GAI 160 via one or more internets and intranets, the Internet, wired or wireless networks, local area networks (LANs), wide area networks (WANs), and any other type of network or combination thereof.

In an example operation, user 110 submits a codebase issue to issue management and ticketing system 120. Agentic software development 140 receives the codebase issue from issue management and ticketing system 120 and begins an agentic software development process. Agentic software development 140 processes the codebase issue and correlates it to a codebase and a behavioral model. An issue context is created from the relevant portions of the codebase and behavioral model. The issue context is used to create a solution to the codebase issue. The solution is tested and interrogated, and the results are added to the issue context such that the next iteration of the agentic software development process benefits from the learning achieved in earlier iterations.

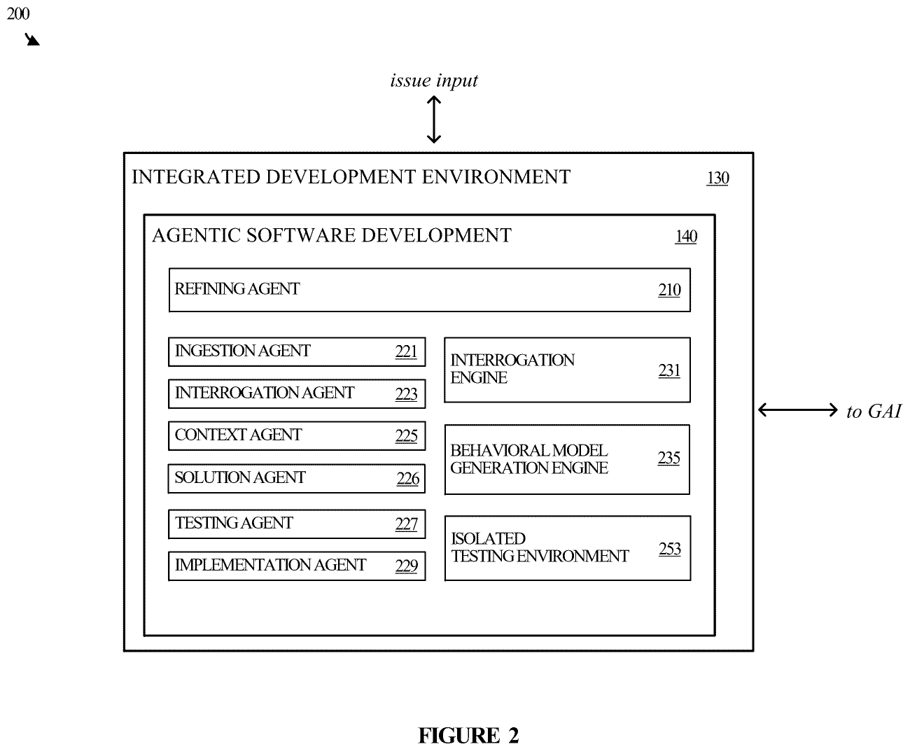

FIG. 2 illustrates operating environment 100 in further detail, represented by environment 200, in an implementation. Environment 200 includes IDE 130 of FIG. 1, which further includes agentic software development 140 of FIG. 1. As illustrated here, and as described in the text associated to FIG. 1, IDE 130 is communicatively coupled with other elements of environment 200. Via those communicative couplings, IDE 130 receives codebase issues and communicates with generative artificial intelligence, such as GAI 160. Agentic software development 140 further includes refining agent 210, ingestion agent 221, interrogation agent 223, context agent 225, solution agent 226, testing agent 227, implementation agent 229, interrogation engine 231, behavioral model generation engine 235, and isolated testing environment 253. The sub-elements of agentic software development 140 are each communicatively coupled with the other sub-elements of agentic software development 140 and with IDE 130.

Refining agent 210 is generally representative of a management layer configured to direct the various agents, modules, and engines of agentic software development 140 in order to carry out an agentic software development process. Refining agent 210 may be an agentic model, agentic software, application code, or the like.

Each of ingestion agent 221, interrogation agent 223, context agent 225, solution agent 226, testing agent 227, and implementation agent 229 are generally representative of an agentic software configured to achieve a variety of goals. Each of ingestion agent 221, interrogation agent 223, context agent 225, solution agent 226, testing agent 227, and implementation agent 229 are communicatively coupled. In some cases, ingestion agent 221, interrogation agent 223, context agent 225, solution agent 226, testing agent 227, and implementation agent 229 communicate with each other directly, while in other cases they may communicate via refining agent 210. Each of ingestion agent 221, interrogation agent 223, context agent 225, solution agent 226, testing agent 227, and implementation agent 229 may leverage other processes of agentic software development 140 such as interrogation engine 231, behavioral model generation engine 235, or isolated testing environment 253, and may also leverage external elements, such as GAI 160 of FIG. 1.

In general, agentic artificial intelligence (AI) refers to AI systems designed to autonomously pursue complex goals and workflows with limited direct human supervision. Agentic AI exhibits autonomous decision-making, planning, and adaptive execution to complete multi-step processes. Beneficially, the flexibility of agentic AI models allows them to operate in dynamic environments without the oversight required to update a traditional AI model when new problems are faced.

Ingestion agent 221 is generally representative of an agentic software configured to receive a codebase issue. Ingestion agent 221 may be an agentic model, agentic software, application code, or the like. Ingestion agent 221 may receive the codebase issue from an issue management and ticketing system, such as issue management and ticketing system 120, or else directly from a user, such as user 110. When directed to receive a codebase issue, ingestion agent 221 may do so by receiving a communication containing a codebase issue from issue management and ticketing system 120 or user 110, or else may query issue management and ticketing system 120 or user 110 for a codebase issue.

Interrogation agent 223 is generally representative of an agentic software configured to identify a codebase and behavioral model associated with the codebase issue. Interrogation agent 223 may be an agentic model, agentic software, application code, or the like. Refining agent 210 directs interrogation agent 223 to interrogate the codebase issue received by ingestion agent 221. An indication of the codebase issue may be transmitted from ingestion agent 221 to interrogation agent 223 directly or else via refining agent 210. Upon receiving the codebase issue, interrogation agent 223 is configured to identify a behavioral model and codebase associated with the codebase issue. Where a behavioral model does not yet exist for the codebase associated with the codebase issue, interrogation agent 223 may leverage behavioral model generation engine 235 to generate a behavioral model for the codebase. Interrogation agent 223, when directed to interrogate a codebase issue, may do so by leveraging an interrogation engine, such as interrogation engine 231. While interrogation engine 231 is illustrated as a separate module, the processes represented by interrogation engine 231 may be encompassed within interrogation agent 223 in some examples.

Behavioral model generation engine 235 monitors one or more run-time operations which execute the codebase to generate trace files (e.g., JSON files) that include information about the behavior of the relevant portion of the codebase. In some embodiments, many trace files are generated related to a single codebase. For example, first behaviors (e.g., structured query language (SQL) connection behaviors) may be in a first trace file, while other behaviors (e.g., web connection behaviors) are maintained in another trace file. As another example, the codebase may be parsed into portions and the behaviors of each portion of the codebase are in a distinct trace file. In any case, the trace files represent the behavior of the codebase in operation. One example of a behavioral model is the APPMAP® tool offered by APPLAND, INC®.

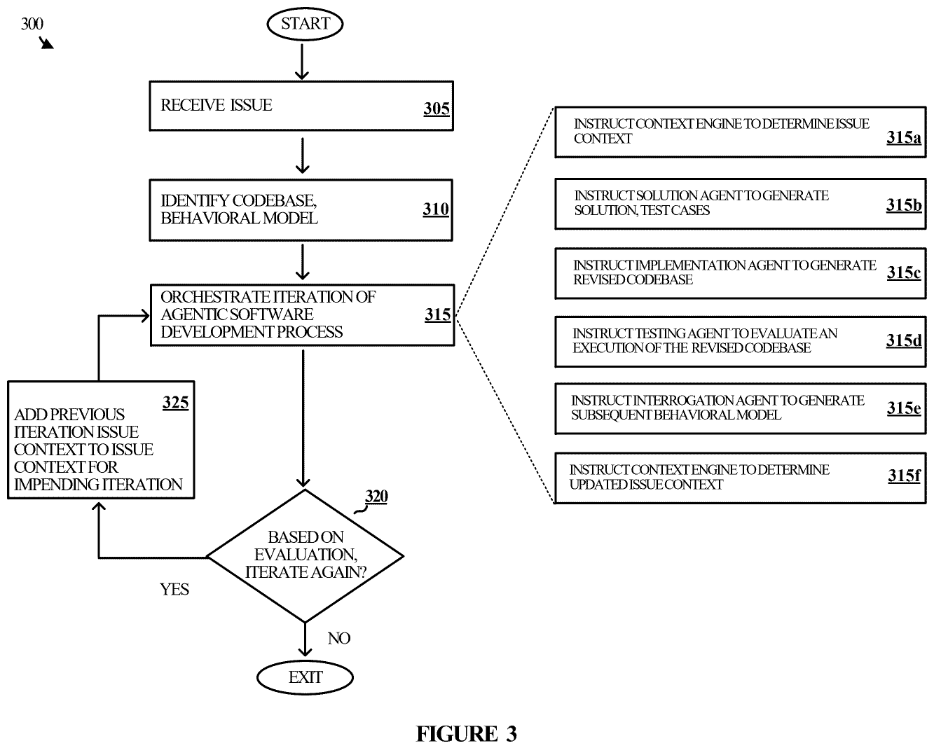

Context agent 225 is generally representative of an agentic software configured to identify one or more relevant portions of each of the codebase and the behavioral model associated with the codebase issue. Context agent 225 may be an agentic model, agentic software, application code, or the like. Refining agent 210 directs context agent 225 to identify portions of the codebase and behavioral model identified by interrogation agent 223. Context agent 225 may identify the relevant content from the behavioral model and the codebase using a keyword search of the behavioral model and of the source code of the codebase. The keyword search of the behavioral model yields matches (code paths, locations, I/O events, SQL queries, HTTP server or client requests) in the behavioral model which are relevant to the user query according to a list of keywords generated based on the user query. From the codebase, context agent 225 extracts code snippets which are associated with the relevant locations in the behavioral model. The system may also perform a keyword search of the codebase itself based on the keyword list to identify relevant content, e.g., relevant code sections. While illustrated in FIG. 3 as internal to context agent 225, the context identification process may be performed by context agent 225 leveraging a separate module of agentic software development 140.

Solution agent 226 is generally representative of an agentic software configured to develop a solution to the codebase issue and test cases to evaluate the provided solution with respect to the codebase. Solution agent 226 may be an agentic model, agentic software, application code, or the like. Solution agent 226 receives the issue context identified by context agent 225, and autonomously queries a generative artificial intelligence model, such as GAI 160 of FIG. 1, for a solution to the codebase issue and the test cases.

Implementation agent 229 is generally representative of an agentic software configured to deploy the solution received at solution agent 226 to a codebase for further processing. Implementation agent 229 may be an agentic model, agentic software, application code, or the like. To deploy the solution, implementation agent 229 generates a revised codebase made up of the codebase first identified with the addition of the solution. The solution may encompass additions to the source code of the codebase, deletions from the source code of the codebase, or revisions to the source code of the codebase.

Testing agent 227 is generally representative of an agentic software configured to test and evaluate the solution by executing the revised codebase with respect to the test cases received at solution agent 226. Testing agent 227 may be an agentic model, agentic software, application code, or the like. To execute the revised codebase, testing agent 227 leverages isolated testing environment 253. Isolated testing environment 253 is separated from the rest of IDE 130 such that codebase executions can be carried out and evaluated without risk to the system at-large. In some cases, isolated testing environment 253 may be a sandbox environment.

In an example application, refining agent 210 directs ingestion agent 221 to receive a codebase issue. Ingestion agent 221 queries an issue management and ticketing system, such as issue management and ticketing system 120 of FIG. 1 and receives a codebase issue in return. Refining agent 210 collects an indication of the codebase issue from ingestion agent 221 and transmits the indication to interrogation agent 223 along with instructions to interrogate the codebase issue. Here, the codebase issue is associated with a codebase and an existing behavioral model. As such, interrogation agent 223 leverages interrogation engine 233 to identify the codebase and behavioral model. At this time, behavioral model generation engine 235 is not called.

Refining agent 210 receives the codebase and behavioral model from interrogation agent 223 and transmits the codebase and behavioral model to context agent 225 along with instructions to identify an issue context. Context agent 225 performs key-word searches on the codebase and behavior model and isolates a number of relevant portions of both the codebase and the behavior model, respectively. The relevant portions make up the issue context. Refining agent 210 receives the issue context from context agent 225 and transmits the issue context to solution agent 226 along with instructions to provide a solution for the codebase issue and test cases to evaluate the codebase issue. Solution agent 226 prompts a generative artificial intelligence model, such as GAI 160, and receives the solution and test cases in return.

Refining agent 210 receives the solution and test cases from solution agent 226 and transmits the solution to implementation agent 229 along with instructions to implement the solution. Implementation agent 229 implements the solution by generating a revised codebase comprised of the initially received codebase and the solution. Here, the solution is several lines of additional source code to be added to the source code of the codebase initially received. Refining agent 210 receives the revised codebase from implementation agent 229 and transmits the revised codebase and test cases to testing agent 227 along with instructions to test the revised codebase with respect to the text cases. Testing agent 227 tests the revised codebase by executing it in isolated testing environment 253 and evaluates the execution. Refining agent 210 then transmits the revised codebase to interrogation agent 223 along with instructions to interrogate the revised codebase and generate a new behavioral model associated with the revised codebase. Interrogation agent 223 generates the new behavioral model and transmits the new behavioral model to context agent 225 via refining agent 210. Context agent 225 identifies the relevant portions of the new behavioral model and revised codebase and returns the relevant portions as the updated issue context to refining agent 210. Solution agent 226 receives the updated issue context develops a subsequent solution and subsequent test case by leveraging generative artificial intelligence. Implementation agent 229, having received the subsequent solution from solution agent 226 via refining agent 210, implements the subsequent solution by generating a further revised codebase made up of a combination of the initially received codebase, the solution, the revised codebase, and the subsequent solution.

Testing agent 227 receives the further revised codebase and subsequent test cases from implementation agent 229 via refining agent 210 and executes the further revised codebase in isolated testing environment 253. Testing agent 227 evaluates the execution of the further revised codebase. Here, refining agent 210 orchestrates another iteration of the agentic software development process based on the evaluation of the most recent execution. Where testing agent 227 determines that the codebase issue is resolved, no additional iteration is performed. Where testing agent 227 determines that the codebase issue is not resolved, refining agent 210 conducts an additional iteration of the agentic software development process. In the ongoing example, the codebase issue is resolved, and no further iteration is performed.

Note that in some scenarios, a solution resulting from multiple iterations of the agentic software development process may be made up of a serial progression of codebases and solutions, while in other scenarios the solution may include a “rolled back solution,” in situations where an earlier solution is more beneficial than a subsequent solution. Beneficially, rolled back solutions increase the flexibility of the agentic software development process in that elements of the solution can be acquired at multiple points during iterations of the agentic software development process. While integrated development environments typically include version control that effectively supports rolled back solutions, copies of various codebase instances can be generated by implementation agent 229 such that any number of prior versions can be memorialized.

FIG. 3 illustrates agentic software development process 300 in an implementation. Agentic software development process 300 may be implemented in program instructions in the context of the software and/or firmware elements of agentic software development 140. The program instructions, when executed by one or more processing devices of one or more computing systems (e.g., computing device 905 in FIG. 9), direct the one or more computing systems to operate as follows, referring parenthetically to the steps in FIG. 3, and in the singular to a computing device for the sake of clarity. While described as coordinated by a refining agent in the description below, any agent may coordinate the agents and behaviors described, or a single software component may perform all elements of the described functionality without departing from the scope and spirit of the present disclosure. Further, the agents described may be called in any order to perform the steps and generate results in any order notwithstanding the order described below.

At step 305, an issue is received. In some embodiments, a refining agent, such as refining agent 210 may direct an ingestion agent, such as ingestion agent 221, to retrieve a codebase issue. In response, the ingestion agent may query an issue management and ticketing system, such as issue management and ticketing system 120 of FIG. 1 and receive a codebase issue in return. In other embodiments, receiving the codebase issue may be performed by a different agent or through a different process. For example, a user may enter a problem statement, and the refining agent may enlist other agents to analyze the problem statement to generate one or more tests to determine whether there is an issue with the codebase or to provide a response to the problem statement. For example, the system may generate a prompt for a generative artificial intelligence model requesting tests for testing the problem statement (e.g., the test agent may be used to generate the tests prior to implementing a solution).

At step 310, the codebase and behavioral model are identified. For example, an interrogation agent, such as interrogation agent 223, may be instructed to, based on the codebase issue received, identify the relevant codebase. In some examples, the codebase issue is associated with a codebase and an existing behavioral model. As such, the interrogation agent may leverage an interrogation engine, such as interrogation engine 233, to identify the codebase and behavioral model. In some embodiments, if tests are generated at step 305, the tests may be used against the codebase to generate the behavioral model.

At step 315, an iteration of the agentic software development process is orchestrated. For example, the refining agent may orchestrate the iteration. The refining agent may, at step 315a, for example, receive the codebase and behavioral model from the interrogation engine and transmit the codebase and behavioral model to a context agent, such as context agent 225, along with instructions to identify an issue context. To identify the issue context, the context agent may, for example, perform key-word searches on the codebase and behavior model and isolate a number of relevant portions of both the codebase and the behavior model, respectively. The relevant portions may be included in the issue context.

The refining agent may, at step 315b, transmit the issue context to a solution agent, such as solution agent 226, along with instructions requesting a solution for the codebase issue. In some embodiments, the solution agent may also be asked for test cases. In embodiments in which the tests were generated at step 305, new tests may or may not be requested. The solution agent may prompt a generative artificial intelligence model, such as GAI 160, and receive the solution and, when requested, test cases in return.

At step 315c, the refining agent may transmit the solution to an implementation agent, such as implementation agent 229, along with instructions to implement the solution. The implementation agent may implement the solution by generating a revised codebase including the initially received codebase and the solution. The refining agent may receive the revised codebase from the implementation agent.

At step 315d, the refining agent may transmit the revised codebase and test cases to a testing agent, such as testing agent 227, along with instructions to test the revised codebase with respect to the test cases. The testing agent may use the tests (i.e., test cases) to test the revised codebase by executing it in an isolated testing environment, such as isolated testing environment 253. The testing agent may evaluate the execution of the test cases against the revised codebase.

At step 315e, the refining agent may transmit the revised codebase to the interrogation agent along with instructions to interrogate the revised codebase and generate a new behavioral model associated with the revised codebase. In some embodiments, step 315e may be performed optionally. For example, step 315e may be performed if another iteration of the process is to be performed. As another example, if the changes are to be rolled back and the revised codebase is not to be maintained, the behavioral model may be unnecessary.

At step 315f, the context agent is directed to identify the relevant portions of the new behavioral model and revised codebase, and to return the relevant portions as the updated issue context to the refining agent. In some embodiments, step 315f is performed optionally. For example, if the revised codebase is not used moving forward (e.g., the changes are rolled back or the solution resolves the issue), new context may be unnecessary.

At step 320, a determination of whether to perform an additional iteration is made. For example, if the testing agent determines that the codebase issue is resolved based on evaluating the revised codebase using the test cases, no additional iteration may be performed. Where the testing agent determines that the codebase issue is not resolved, the refining agent may conduct an additional iteration of the agentic software development process. In such cases, the codebase revision may be rolled back and the process may use the prior iteration information to provide additional context to the current iteration at step 325. In some embodiments, the revised codebase and associated behavioral model may be used in the next iteration. Whether the revised codebase is used or rolled back may be determined on a system-by-system, user-by-user, codebase-by-codebase, iteration-by-iteration, and/or any other relevant basis.

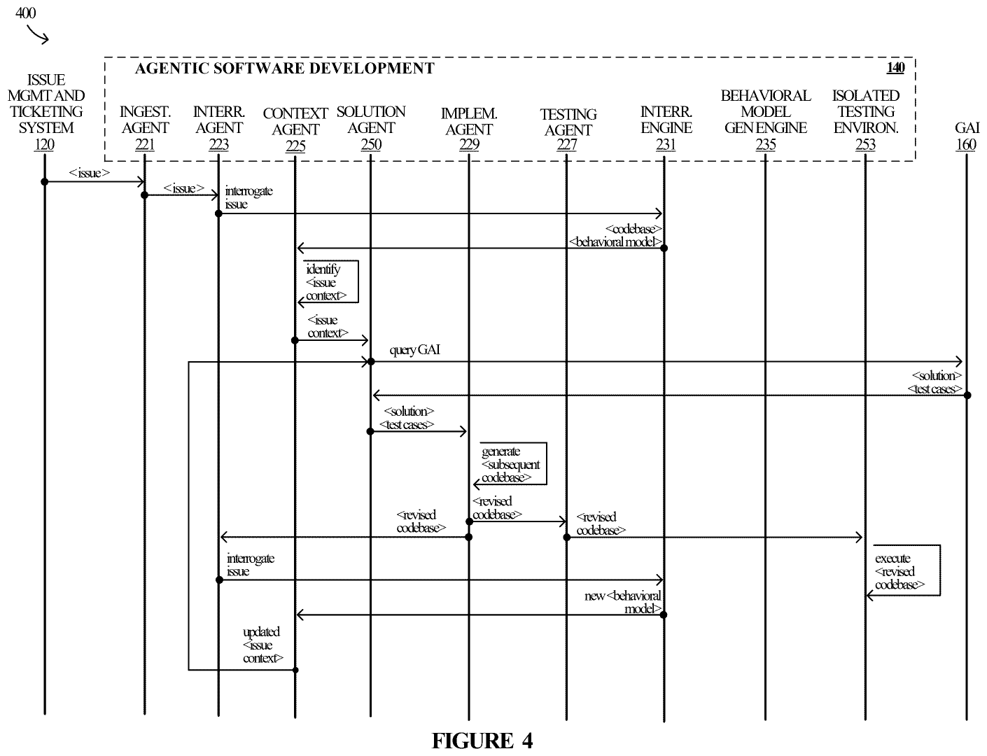

FIG. 4 illustrates operational sequence 400 in the context of environment 200 in an implementation. Operational sequence 400 includes issue management and ticketing system 120, ingestion agent 221, interrogation agent 223, context agent 225, solution agent 226, implementation agent 229, testing agent 227, interrogation engine 233, behavioral model generation engine 235, isolated testing environment 255, and GAI 160 of FIG. 1 and FIG. 2, respectively. Each of the elements above are described in further detail in the associated text to FIG. 1 and FIG. 2, respectively. Note that while operational sequence 400 illustrates various agents communicating directly, the various agents may also communicate via a refining agent such as refining agent 210 of FIG. 2. Further note that while the various agents of operational sequence 400 are instructed to perform their respective processes by a refining agent such as refining agent 210, the refining agent is omitted from FIG. 4 for clarity.

Issue management and ticketing system 120 transmits a codebase issue to ingestion agent 221. Ingestion agent 221 transmits the codebase issue to interrogation agent 223 for processing. Interrogation agent 223 leverages interrogation engine 233 to identify a codebase and an existing behavioral model associated with the codebase issue. Context agent 225 receives the codebase and behavioral model and identifies an issue context. Solution agent 226 receives the issue context and leverages GAI 160 to generate a solution to the codebase issue and test cases to evaluate the solution. Implementation agent 229 receives the solution and generates a revised codebase made up of the initial codebase associated with the codebase issue and the solution. The revised codebase is evaluated in isolated testing environment 253. Interrogation agent 223 also receives the revised codebase and leverages interrogation engine 233 to generate a new behavioral model associated with the revised codebase. The new behavioral model is received at context agent 225, where an updated issue context is generated. During a first iteration of agentic software development, a subsequent solution is created by default procedure. During a subsequent iteration of agentic software development, any additional iterations of agentic software development are conditioned upon the resolution of the codebase issue. Where testing agent 227 determines the codebase issue has not been resolved, additional iterations of agentic software development may be carried out.

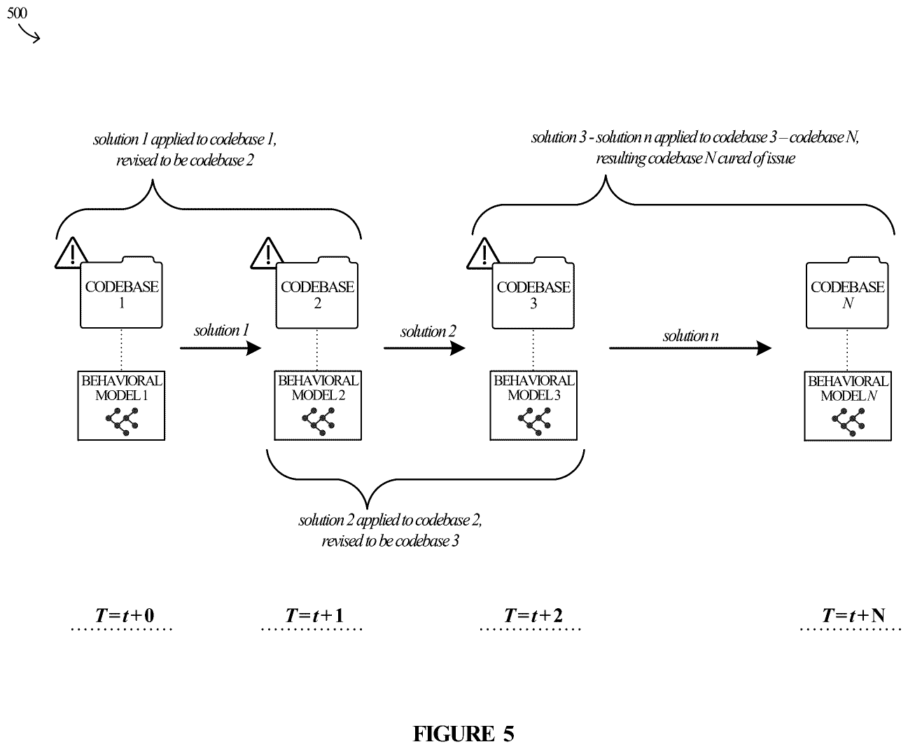

FIG. 5 illustrates operational scenario 500 in the context of environment 200 in an implementation. FIG. 5 is illustrated from left to right over time T to show a progression of a codebase as iterations of agentic software development are performed.

At T=t+0, a codebase issue has been received and correlated with a codebase and a behavioral model, which have been used to identify an issue context. Solution 1 has been generated for the codebase issue based on the issue context. By T=t+1, solution 1 has been applied to codebase 1. With the changes encompassed in solution 1, codebase 1 is revised to be codebase 2. Codebase 2 is used to generate behavioral model 2, which is used to determine an updated issue context (e.g., the state of the codebase issue after having applied the first solution). Solution 2 is generated based on the updated issue context. By T=t+2, solution 2 has been applied to codebase 2. With the changes encompassed in solution 2, codebase 2 is revised to be codebase 3. Codebase 3 is used to generate behavioral model 3, which is used to determine a further updated issue context. This procedure may repeat a number of times before codebase N is achieved, where codebase N is generally representative of a codebase having the codebase issue resolved. In some cases, only a few iterations of agentic software development are necessary to resolve the codebase issue, while in others a greater number of iterations are required. Beneficially in either case, the overall success rate of agentic software development with regard to resolving codebase issues is significantly improved over existing benchmarks without the addition of oversight.

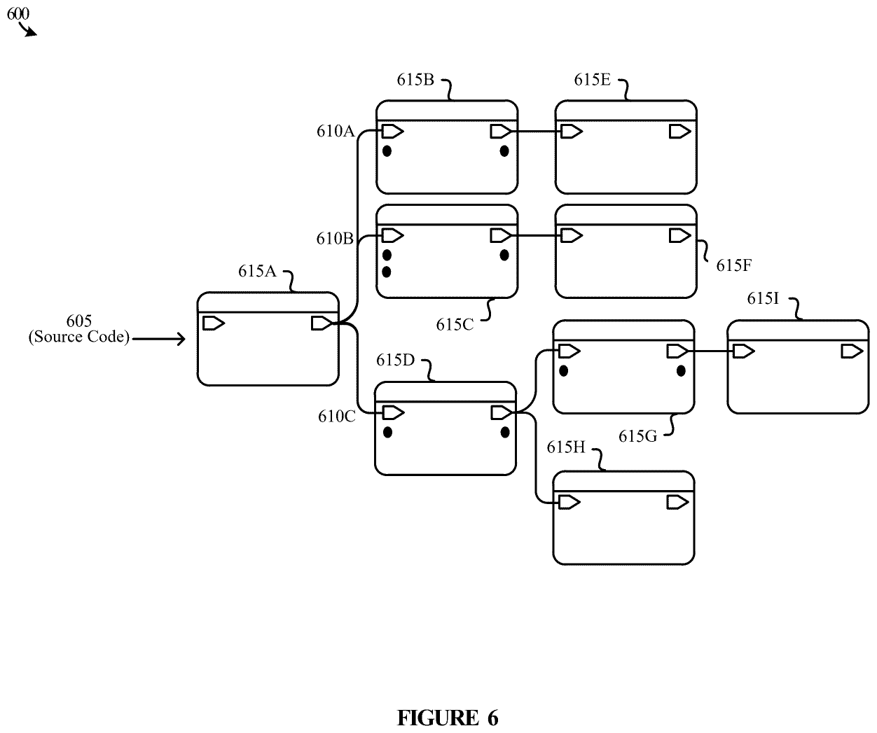

FIG. 6 illustrates visual depiction 600 which is representative of a visual depiction of a behavioral model or portion thereof in an implementation. Visual depiction 600 is a visual representation of the behavioral model of the source code of codebase 605. Codebase 605 is generally representative of a codebase used to generate behavioral models. The behavioral model is generated based on a run-time operation and analysis of a codebase 605. Codebase 605 may be source code in any coding language. Examples of codebase 605 include but are not limited to web applications, locally installed applications, and applications served from a cloud. Visual depiction 600 depicts an example of a behavioral model that may be created by a generation module, such as interrogation agent 223 of FIG. 2.

In some implementations, codebase 605 is submitted to a generation module that generates the corresponding behavioral model that represents the run-time operation of the codebase 605. The generation module may exhaustively probe the codebase 605 to identify parameters, connection points, and the like to ensure a thorough representation of the codebase 605 in operation. The behavioral model generated by the generation module may include information by which other diagrams, such as sequence diagrams, can be rendered. The behavioral model may also include information by which a prompt to a foundation model concerning a portion of the codebase can be populated, such as relationships between blocks of code in codebase 605.

The behavioral model of codebase 605 may be stored as a visual depiction, such as visual depiction 600, or may instead be stored as data representing the behavior of the codebase 605 including connection information, operational paths (e.g., code paths), functional categories, and the like. As shown in visual depiction 600, operational paths 610A, 610B, and 610C represent the path of the codebase in operation. More specifically, operational paths 610A, 610B, and 610C detail the execution of codebase 605 functions in real-time. The code blocks 615A, 615B, 615C, 615D, 615E, 615F, 615G, 615H, 615I represent data transformations or other operations that include one or more inputs from operational paths 610 and one or more outputs to other operational paths.

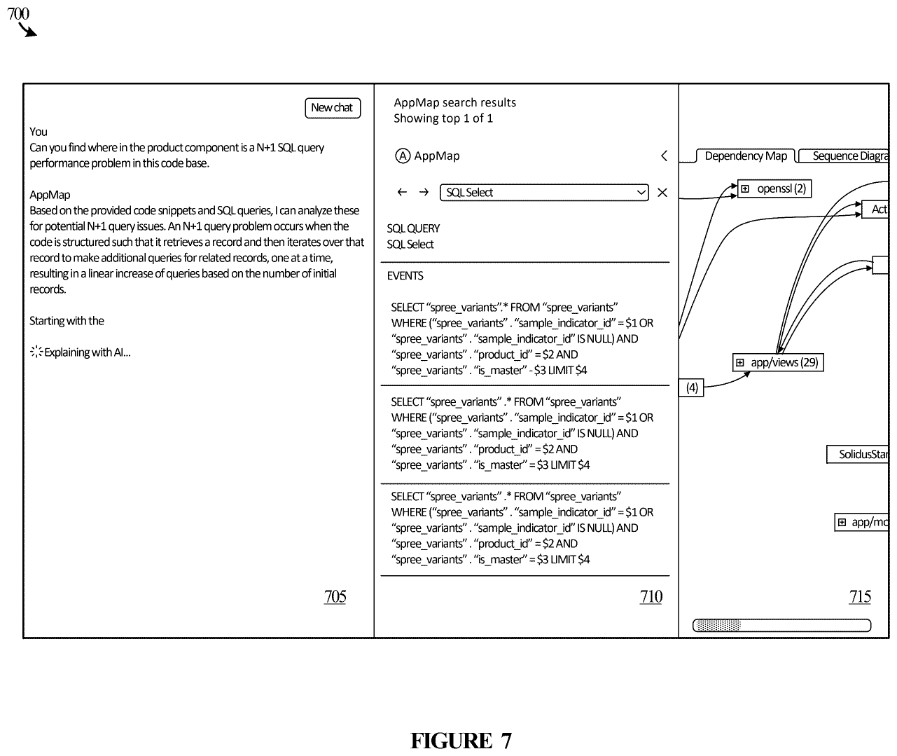

FIG. 7 illustrates user interface 700 with chat window 705 depicting a question submitted by the user and a response generated by the foundation model based on a prompt designed by a resolution module of the system. The question submitted by the user is generally representative of a statement containing an issue. In this case, the user query states “Can you find where in the product component is a N+1 SQL query performance problem in this case base.” An interrogation module of the system interrogates the behavioral model of the relevant codebase and identifies trace files relating to SQL queries according to a search based on the user query. The interrogation module then identifies and extracts relevant code snippets from the identified trace files and provides them to the resolution module. The resolution module populates the prompt with the user query, the identified trace files, and the code snippets. The beginning of the response is shown in chat window 705. As shown in code view 710, particular SQL queries can quickly be found. In some embodiments, the resolution module can utilize the interrogation module to find the particular portions of the codebase based on the response and modify the code view to zoom to the particular code snippets related to the response.

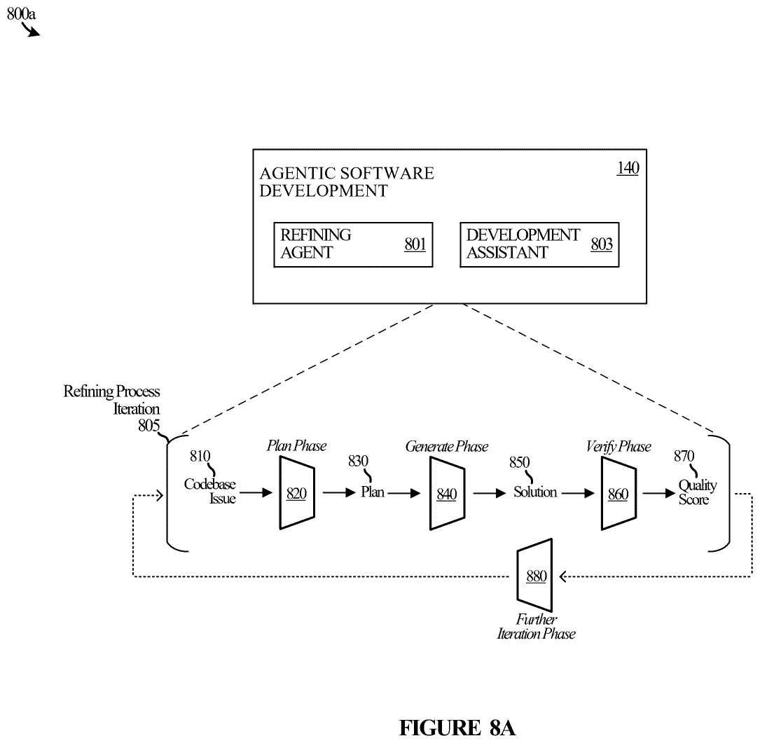

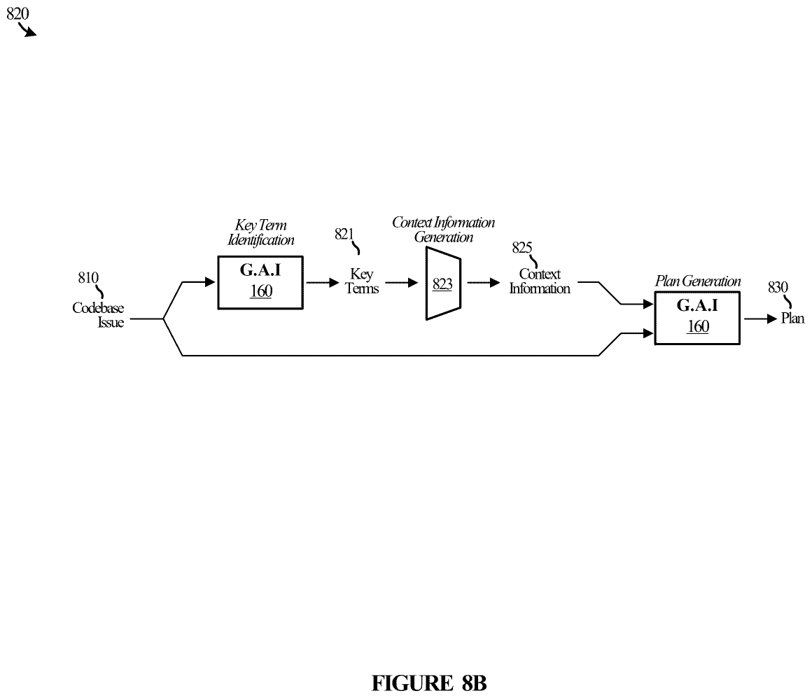

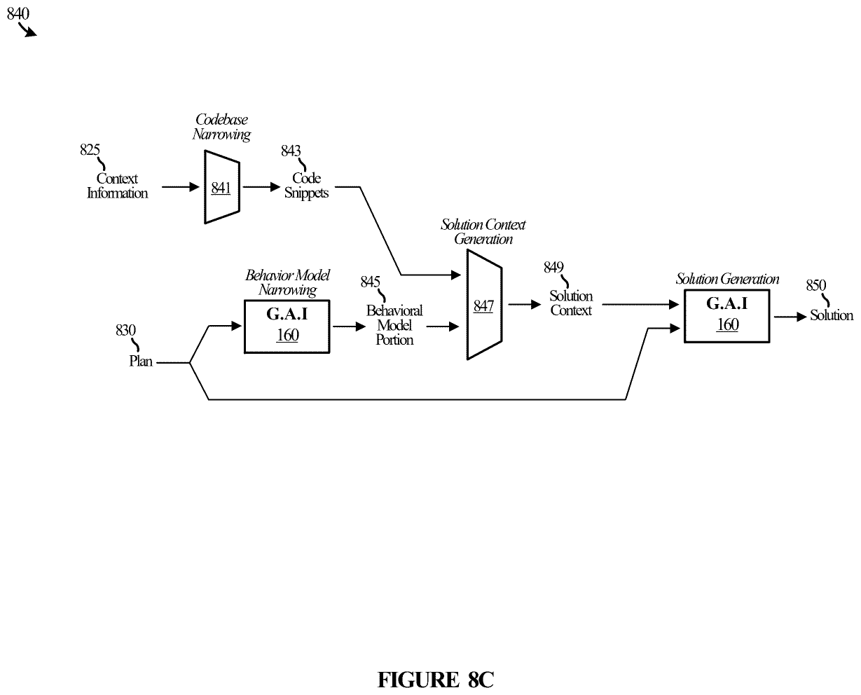

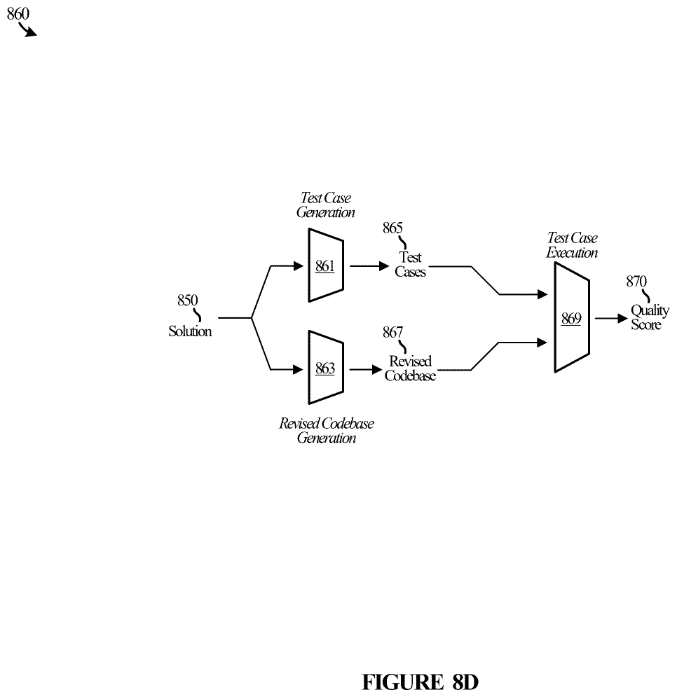

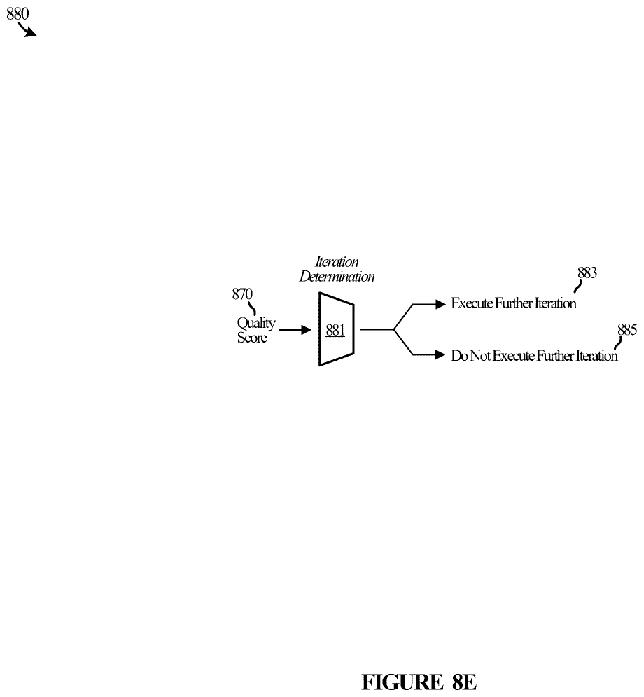

FIG. 8A illustrates operating environment in further detail 800a, hereinafter represented by environment 800a in accordance with some embodiments of the present technology. Environment 800a includes agentic software development 140 of FIG. 1. Agentic software development 140 is described in further detail in the text associated with FIG. 1.

Agentic software development 140 as illustrated in FIG. 8A further includes refining agent 801, development assistant 803, and refining process iteration 805. Refining process iteration 805 further includes codebase issue 810, plan phase 820, plan 830, generate phase 840, solution 850, verify phase 860, quality score 870, and further iteration phase 880. Each of plan phase 820, generate phase 840, and verify phase 860 may be elements of development assistant 803 or may be software associated with another application. The elements and processes of FIG. 8A can be evaluated with regard to the elements and processes of FIG. 1 and FIG. 2. Further, refining process iteration 805 may include the same or similar agents as those described with respect to orchestrating an iteration of agentic software development process 315 of FIG. 3.

Refining agent 801 is generally representative of software agent that agentically orchestrates instances of refining process iteration 805, an example of which is also given by refining agent 210 of FIG. 2 and described in additional detail at step 315 of process 300 in FIG. 3. Refining agent 801 may be hardware, software, or firmware. To agentically orchestrate instances of refining process iteration 805, refining agent 801 leverages development assistant 803.

Development assistant 803 is generally representative of software, hardware, or firmware for providing an artificially intelligent software architect that can be leveraged in software development. Development assistant 803 is directed, by refining agent 801, to carry out the various phases of refining process iteration 805. In particular, refining agent 801 directs development assistant 803 to execute plan phase 820, generate phase 840, verify phase 860, and further iteration phase 880, respectively. In some implementations, development assistant 803 and the processes performed therein are effectively equivalent to an aggregate of ingestion agent 221, interrogation agent 223, context agent 225, testing agent 227, implementation agent 229, interrogation engine 231, behavioral model generation engine 235, and isolated testing environment 253, each of FIG. 2, respectively. As discussed above, each of these agents may operate in coordination or independently of each other. As such, each agent may be called to perform its function in any order to effect a solution to an issue within a codebase (e.g., codebase issue 810).

Refining process iteration 805 is a single iteration of a refining process designed to resolve codebase issues with minimal oversight. Refining process iteration 805 is initiated and orchestrated by refining agent 801. In particular, refining agent 801 submits codebase issue 810 to plan phase 820 and receives plan 830 in return. Refining agent 801 may submit plan 830 to generate phase 840 and receive solution 850 in return. Refining agent 801 may further submit solution 850 to verify phase 860 and receive quality score 870 in return. Refining agent 801 may determine whether to orchestrate a further instance of refining process iteration 805 based on quality score 870 output by verify phase 860. Where further iteration phase 880 results in the orchestration of a further instance of refining process iteration 805, an updated codebase issue may be fed to plan phase 820. Where further iteration phase 880 results in no orchestration of further instances of refining process iteration 805, the process may be complete. Additional detail describing the operation phases of refining process iteration 805 is included in the associated text for FIG. 8B through FIG. 8E.

To describe refining process iteration 805 in more detail, it may be initiated by refining agent 801, or in some cases, by a user interface. For example, refining process iteration 805 may be initiated via user interface 700 of FIG. 7. Refining agent 801 may receive the codebase issue from a user interface or from an issue management system. In some scenarios, refining agent 801 evaluates a codebase to identify a codebase issue. The codebase issue 810 may be obtained in any way. For example, a ticket management system may provide codebase issue 810 upon request from a queue of tickets, which may be prioritized. As another example, a user may submit a problem statement. In some embodiments, the system may generate tests based on the problem statement using the testing agent prior to requesting a solution. Further, the tests may be executed against the codebase to generate the relevant behavioral model used to identify the solution. In some embodiments, these steps may be performed prior to submission of the codebase issue for generating a plan. In other words, the agents described may be implemented in a variety of orders to arrive at the solution 850.

In any case, once refining agent 801 identifies or receives a codebase issue, refining agent 801 initiates an iteration of refining process iteration 805 and submits the codebase issue to development assistant 803 for commencement of plan phase 820. Development assistant 803 carries out plan phase 820 and returns plan 830 to refining agent 801. Refining agent 801 submits plan 830 to development assistant 803 for commencement of generate phase 840. Development assistant 803 carries out generate phase 840 and returns solution 850 to refining agent 801. Refining agent 801 submits solution 850 to development assistant 803 for commencement of verify phase 860. Development assistant 803 carries out verify phase 860 and returns quality score 870 to refining agent 801. Refining agent 801 then determines, based on quality score 870, to execute a further instance of refining process iteration 805. In some cases, refining agent 801 determines, based on quality score 870, not to execute a further instance of refining process iteration 805.

FIG. 8B illustrates plan phase 820 of refining process iteration 805 in further detail in accordance with some embodiments of the present technology. The elements of FIG. 8B can be assessed with regard to the elements of FIG. 8A, FIG. 1, and FIG. 2, respectively. Plan phase 820 includes codebase issue 810, a first instance of GAI 160, key terms 821, context information generation 823, a second instance of GAI 160, and plan 830.

Plan phase 820 as illustrated in FIG. 8B is representative of a portion of the operation of refining process iteration 805 by development assistant 803 as directed by refining agent 801. In particular, plan phase 820 is representative of a phase of refining process iteration 805 in which a plan for responding to codebase issue 810 is generated. As illustrated in FIG. 8B, codebase issue 810 is used both as a direct input and an indirect input to GAI 160.

Development assistant 803 submits codebase issue 810 and a prompt requesting key terms corresponding to codebase issue 810 to GAI 160 for key term identification. In response, GAI 160 returns key terms 821. Key terms 821 are utilized by development assistant 803 in context information generation 823. Development assistant 803 generates context information 825, which includes at least a portion of the initial codebase and at least a portion of the behavioral model. Development assistant 803 feeds context information 825, along with codebase issue 810 and instructions to generate plan 830, into GAI 160 for plan generation. In response, GAI 160 returns plan 830. In some cases, plan 830 includes a number of steps for responding to codebase issue 810.

FIG. 8C illustrates generate phase 840 of refining process iteration 805 in further detail in accordance with some embodiments of the present technology. The elements of FIG. 8C can be assessed with regard to the elements of FIG. 8A, FIG. 8B, FIG. 1, and FIG. 2, respectively. Generate phase 840 includes context information 825, plan 830, codebase narrowing 841, code snippets 843, a first instance of GAI 160 for behavior model narrowing, behavior model portion 845, solution context generation 847, solution context 849, a second instance of GAI 160 for solution generation, and solution 850. Context information 825, plan 830, and GAI 160 are substantially the same as context information 825, plan 830, and GAI 160 as described in the preceding paragraphs.

Generate phase 840 as illustrated in FIG. 8C is representative of a portion of the orchestration of refining process iteration 805 by development assistant 803 as directed by refining agent 801. In particular, generate phase 840 is representative of a phase of refining process iteration 805 in which a solution for responding to codebase issue 810 is generated.

Plan 830 is submitted to development assistant 803 by refining agent 801. Development assistant 803 submits plan 830 and the behavior model corresponding to codebase issue 810 to GAI 160 along with instructions to narrow the behavior model to relevant portions corresponding to plan 830. In some cases, key terms 821 of FIG. 8B are also submitted to the first instance of GAI 160 by development assistant 803 in order to narrow the behavior model to relevant portions. In response, development assistant 803 receives behavior model portion 845 from GAI 160. Development assistant 803 then feeds behavior model portion 845 to solution context generation 847.

Context information 825 is also leveraged in generate phase 840. Context information 825 is submitted to codebase narrowing 841 by development assistant 803. Code snippets 843 are produced in response. Code snippets 843 are portions of the codebase associated with codebase issue 810. Beneficially, narrowing the codebase to code snippets 843 significantly increases the efficiency with which artificial intelligence models can process codebase issue 810. Further, the token cost of having GAI 160 evaluate code snippets 843 as opposed to an entire codebase associated with codebase issue 810 is greatly reduced.

Code snippets 843 and behavioral model portion 845 are both fed to solution context generation 847 by development assistant 803. Development assistant 803 processes code snippets 843 and behavioral model portion 845 and produces solution context 849. Solution context 849, along with plan 830, are submitted to the second instance of GAI 160 for solution generation. GAI 160 returns solution 850 in response. In some cases, solution 850 includes a number of steps for responding to codebase issue 810.

FIG. 8D illustrates verify phase 860 of a refining process iteration in further detail in accordance with some embodiments of the present technology. The elements of FIG. 8D can be assessed with regard to the elements of FIG. 8A, FIG. 8B, FIG. 8C, FIG. 1, and FIG. 2, respectively. Verify phase 860 includes solution 850, test case generation 861, revised codebase generation 863, test cases 865, revised codebase 867, test case execution 869, and quality score 870.

Verify phase 860 as illustrated in FIG. 8D is representative of a portion of the orchestration of refining process iteration 805 by development assistant 803 as directed by refining agent 801. In particular, verify phase 860 is representative of a phase of refining process iteration 805 in which quality score 870 is generated for solution 850 that corresponds to the ability of solution 850 to respond to codebase issue 810. Where solution 850 completely mitigates codebase issue 810, quality score 870 will be relatively high. Where solution 850 has no effect on codebase issue 810, quality score 870 will be relatively low.

Refining agent 801 submits solution 850 to development assistant 803 along with instructions to verify solution 850. In response, development assistant 803 submits solution 850 to test case generation 861 and to revised codebase generation 863. Development assistant 803 receives test cases 865 in response from test case generation 861. Test cases 865 are representative of test cases against which solution 850 can be executed and evaluated. In particular, test cases 865 correspond to codebase issue 810. In response to submitting solution 850 to revised codebase generation 863, development assistance receives revised codebase 867. Revised codebase 867 is representative of a codebase generated based on the initial codebase and solution 850. Development assistant 803 submits test cases 865 and revised codebase 867 to test case execution, where each of test cases 865 are executed against revised codebase 867. Based on the test case executions, development assistant 803 produces a quality score. The quality score is representative of the ability of solution 850 to respond to codebase issue 810.

FIG. 8E illustrates further iteration phase 880 of a refining process iteration in further detail in accordance with some embodiments of the present technology. Further iteration phase 880 includes quality score 870, iteration determination 881, execute further iteration 883, and do not execute further iteration 885.

Further iteration phase 880 as illustrated in FIG. 8E is representative of a portion of the orchestration of refining process iteration 805 by development assistant 803 as directed by refining agent 801. In particular, further iteration phase 880 is representative of a phase of refining process iteration 805 in which quality score 870 for solution 850 is evaluated to determine if a further instance of refining process iteration 805 should be orchestrated.

Development assistant 803 submits quality score 870 to iteration determination 881. The output of iteration determination 881 is based on quality score 870. Where quality score 870 is low, or in some cases below a predetermined limit, the outcome of iteration determination 881 is execute further iteration 883. Elsewhere, where quality score 870 is high, or in some cases above a predetermined limit, the outcome of iteration determination 881 is do not execute further iteration 885.

Where the outcome of iteration determination 881 is execute further iteration 883, refining agent 801 generates an updated codebase issue based on the revised codebase. Refining agent 801 then orchestrates a further instance of refining process iteration 805 based on the updated codebase issue.

FIG. 9 illustrates computing device 905, which is representative of any system or collection of systems in which the various applications, processes, services, and scenarios disclosed herein may be implemented. Examples of computing device 905 include, but are not limited to server computers, web servers, cloud computing platforms, and data center equipment, as well as any other type of physical or virtual server machine, container, and any variation or combination thereof. (In some examples, computing device 905 may also be representative of desktop and laptop computers, tablet computers, and the like.)

Computing device 905 may be implemented as a single apparatus, system, or device or may be implemented in a distributed manner as multiple apparatuses, systems, or devices. Computing device 905 includes, but is not limited to, processing system 925, storage system 910, software 915, communication interface system 920, and user interface system 930. Processing system 925 is operatively coupled with storage system 910, communication interface system 920, and user interface system 930.

Processing system 925 loads and executes software 915 from storage system 910. Software 915 includes and implements agentic software development 935, which is representative of the processes discussed with respect to the preceding Figures, such as agentic software development process 300. When executed by processing system 925, software 915 directs processing system 925 to operate as described herein for at least the various processes, operational scenarios, and sequences discussed in the foregoing implementations. Computing device 905 may optionally include additional devices, features, or functionality not discussed for purposes of brevity.

Referring still to FIG. 9, processing system 925 may include a micro-processor and other circuitry that retrieves and executes software 915 from storage system 910. Processing system 925 may be implemented within a single processing device but may also be distributed across multiple processing devices or sub-systems that cooperate in executing program instructions. Examples of processing system 925 include general purpose central processing units, microcontroller units, graphical processing units, application specific processors, integrated circuits, application specific integrated circuits, and logic devices, as well as any other type of processing device, combinations, or variations thereof.

Storage system 910 may comprise any computer readable storage media readable by processing system 925 and capable of storing software 915. Storage system 910 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. Storage system 910 may be implemented as a single storage device but may also be implemented across multiple storage devices or sub-systems co-located or distributed relative to each other. Storage system 910 may comprise additional elements, such as a controller, capable of communicating with processing system 925 or possibly other systems.

Software 915 (including agentic software development 935) may be implemented in program instructions and among other functions may, when executed by processing system 925, direct processing system 925 to operate as described with respect to the various operational scenarios, sequences, and processes illustrated herein. For example, software 915 may include program instructions for implementing agentic software development processes and procedures as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 915 may include additional processes, programs, or components, such as operating system software, virtualization software, or other application software. Software 915 may also comprise firmware or some other form of machine-readable processing instructions executable by processing system 925.

In general, software 915, when loaded into processing system 925 and executed, transforms a suitable apparatus, system, or device (of which computing device 905 is representative) overall from a general-purpose computing system into a special-purpose computing system customized to support agentic software development as described herein. Indeed, encoding software 915 on storage system 910 may transform the physical structure of storage system 910. The specific transformation of the physical structure may depend on various factors in different implementations of this description. Examples of such factors may include, but are not limited to, the technology used to implement the storage media of storage system 910 and whether the computer-storage media are characterized as primary or secondary storage, as well as other factors.

For example, if the computer readable storage media are implemented as semiconductor-based memory, software 915 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 920 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 905 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A method, comprising:
receiving, at a refining agent, a codebase issue, wherein the codebase issue is associated with an initial codebase and a behavioral model that represents behavior of the initial codebase during an execution of the initial codebase;
orchestrating, by the refining agent, a first iteration of a refining process, the orchestrating comprising directing a development assistant to:
generate a plan, wherein to generate the plan, the development assistant is configured to:
identify, based on the behavioral model, context information corresponding to the codebase issue, wherein the context information includes at least a portion of the initial codebase and at least a portion of the behavioral model; and
generate a plan prompt to elicit a reply from a foundation model, wherein the plan prompt tasks the foundation model with generating the plan, and wherein the plan prompt includes the context information and the codebase issue,
generate a solution comprising new code to include in the initial codebase, wherein to
generate the solution, the development assistant is configured to:
generate a solution prompt to elicit a reply from the foundation model, wherein the solution prompt includes the context information and the plan, and the solution prompt tasks the foundation model with generating the solution for the codebase issue based on the plan, and
verify the solution, wherein to verify the solution, the development assistant is configured to:
generate test cases corresponding to the codebase issue;
generate a revised codebase comprising the new code; and
execute the test cases against the revised codebase;
determining, by the refining agent, a quality score for the solution based on executing the test cases; and
executing, based on the quality score, a second iteration of the refining process.

2. The method of claim 1, further comprising:
identifying, based on the codebase issue, the portion of the behavioral model corresponding to the codebase issue, and
identifying, based on the portion of the behavioral model, the portion of the initial codebase corresponding to the codebase issue.

3. The method of claim 2, wherein identifying the portion of the behavioral model corresponding to the codebase issue comprises:
generating a keyword list based on the codebase issue; and
searching the behavioral model for locations in the behavioral model associated with the codebase issue based on the keyword list.

4. The method of claim 1, further comprising:
prior to orchestrating the first iteration of the refining process:
determining, by the refining agent, that the behavioral model is not generated; and
generating, by the refining agent, the behavioral model, the generating comprising:
executing the initial codebase, and
recording the executing of the initial codebase.

5. The method of claim 1, further comprising:
determining, subsequent to the second iteration, a second quality score; and
not executing, based on the second quality score, further iterations of the refining process for the codebase issue.

6. The method of claim 1, wherein the plan comprises a plurality of steps designed to respond to the codebase issue.

7. The method of claim 1, wherein:
to generate the solution, the development assistant is further configured to submit a solution context to the foundation model; and
the solution context comprises one or more code snippets selected from the initial codebase corresponding to the codebase issue.

8. The method of claim 1, further comprising:
prior to executing the second iteration of the refining process, generating, by the refining agent, an updated behavioral model corresponding to the revised codebase.

9. The method of claim 1, wherein the second iteration comprises refining the revised codebase.

10. The method of claim 1, wherein the second iteration comprises refining the initial codebase.

11. The method of claim 1, wherein receiving the codebase issue at the refining agent comprises receiving the codebase issue from an issue management system.

12. The method of claim 1, wherein receiving the codebase issue at the refining agent comprises receiving the codebase issue via a user interface.

13. The method of claim 1, wherein receiving the codebase issue at the refining agent comprises:
receiving the codebase issue via a user interface; and
receiving, in association with the codebase issue, a command input, wherein the command input comprises one or more specific software agents, one or more portions of the development assistant, one or more issue types, one or more test case types, or a combination thereof.

14. A computer readable storage media device having program instructions stored thereon that, when executed by at least one processor of a computing device, direct the computing device to:
receive, at a refining agent, a codebase issue, wherein the codebase issue is associated with an initial codebase and a behavioral model that represents behavior of the initial codebase during an execution of the initial codebase;
orchestrate, by the refining agent, a first iteration of a refining process, wherein to orchestrate the first iteration of the refining process, the refining agent directs a development assistant to:
generate a plan, wherein to generate the plan, the development assistant is configured to:
identify, based on the behavioral model, context information corresponding to the codebase issue, wherein the context information includes at least a portion of the initial codebase and at least a portion of the behavioral model; and
generate a plan prompt to elicit a reply from a foundation model, wherein the plan prompt tasks the foundation model with generating the plan, and
wherein the plan prompt includes the context information and the codebase issue,
generate a solution comprising new code to include in the initial codebase, wherein to generate the solution, the development assistant is configured to:
generate a solution prompt to elicit a reply from the foundation model, wherein the solution prompt includes the context information and the plan, and the solution prompt tasks the foundation model with generating the solution for the codebase issue based on the plan, and
verify the solution, wherein to verify the solution, the development assistant is configured to:
generate test cases corresponding to the codebase issue;
generate a revised codebase comprising the new code; and
execute the test cases against the revised codebase;
determine, by the refining agent, a quality score for the solution based on executing the test cases; and
execute, based on the quality score, a second iteration of the refining process.

15. The one or more computer readable storage media of claim 14, wherein the program instructions directing the at least one processor to receive the codebase issue further comprise instructions that, when executed, cause the at least one processor to:
identify, based on the codebase issue, the portion of the behavioral model corresponding to the codebase issue, and
identify, based on the portion of the behavioral model, the portion of the initial codebase corresponding to the codebase issue.

16. The one or more computer readable storage media of claim 15, wherein the program instructions directing the at least one processor to identify the portion of the behavioral model corresponding to the codebase issue further comprise instructions that, when executed, cause the at least one processor to:
generate a keyword list based on the codebase issue; and
search the behavioral model for locations in the behavioral model associated with the codebase issue based on the keyword list.

17. The one or more computer readable storage media of claim 14, wherein the program instructions further comprise instructions that, when executed, cause the at least one processor to:
prior to orchestrating the first iteration of the refining process:
determine, by the refining agent, that the behavioral model is not generated; and
generate, by the refining agent, the behavioral model, the generating comprising:
executing the initial codebase, and
recording the executing of the initial codebase.

18. The one or more computer readable storage media of claim 14, wherein the program instructions further comprise instructions that, when executed, cause the at least one processor to:
determine, subsequent to the second iteration, a second quality score; and
not execute, based on the second quality score, further iterations of the refining process for the codebase issue.

19. The one or more computer readable storage media of claim 14, wherein the plan comprises a plurality of steps designed to respond to the codebase issue.

20. The one or more computer readable storage media of claim 14, wherein:
to generate the solution, the development assistant is further configured to submit a solution context to the foundation model; and
the solution context comprises one or more code snippets selected from the initial codebase corresponding to the codebase issue.
